(19) United States
(12) Patent Application Publication
(10) Pub. No.: US 2025/0239109 A1
(43) Pub. Date: Jul. 24, 2025

(54) REMOTE MONITORING OF ASSETS

(71) Applicant: Bridgestone Mobility Solutions B.V., Amsterdam (NL)

(72) Inventors: Clement Robert HABIMANA, Leipzig (DE); Jan SCHÄFER, Leipzig (DE); Jan BAST-LÖFFLER, Leipzig (DE); Szymon GAJEK, Warsaw (PL); Andre POMSEL, Leipzig (DE)

(21) Appl. No.: 18/698,417

(22) PCT Filed: Oct. 4, 2022
(86) PCT No.: PCT/EP2022/077613

§ 371 Date: Apr. 4, 2024

(30) Foreign Application Priority Data
Oct. 4, 2021 (EP) 21200825.4

(51) Int. Cl. G07C 5/00; G07C 5/08

(52) U.S. Cl. CPC G07C 5/008; G07C 5/0808

(57) ABSTRACT

An asset monitoring system comprises one or more asset sensors (7) located on an asset (5), a vehicle receiver device (17) located on a nearby vehicle (3), and a remote server (19). A method for determining a coupling between the asset (5) and the vehicle (3) comprises: receiving input information indicating that one or more sensors are asset sensors (7) located on the asset (5) and mapping the asset sensors to the asset; sending asset sensor data (8) from the asset sensors located on the asset to the vehicle receiver device (17) via one or more wireless signals; transmitting the asset sensor data from the vehicle receiver device (17) to the remote server (19); and using the mapping of the asset sensors at the remote server (19) to determine whether a coupling exists between the nearby vehicle (3) and the asset (5), based on the asset sensor data.

### TECHNICAL FIELD

The present invention relates to remote monitoring of assets, and in particular to a method for determining a coupling between an asset and a vehicle, to an asset monitoring system and a method of remotely monitoring moving assets.

### BACKGROUND

Wheel speed sensors which accurately measure wheel speed are known. These sensors may be integrated with or mounted on vehicle or asset tires and can measure the turning speed of the tire in order to determine the speed of a vehicle or asset. Such wheel speed sensors may be integrated with a tire pressure monitoring system (TPMS), and can additionally monitor the pressure and temperature of the tires. There are some fleet management systems that use TPMS sensors fitted on tires to report tire pressures. For example, “FleetPulse” from Bridgestone includes an app running on a driver's mobile phone and when the driver walks around the vehicle the app can record tire pressure readings. This system monitors tire pressures separately for each vehicle in a fleet.

It is known to use a telematics control unit (TCU) to track the positions of fleets of vehicles and assets associated with the vehicles. This enables a fleet owner to view the live positon and movements of the complete fleet on a map, as well as a historical overview of the behaviour of all vehicles and assets. However, such remote tracking requires information to be provided about which assets and vehicles are coupled together. One common process is to manually maintain a list of which vehicle is coupled to which asset. Another process is to have GPS hardware on the TCUs mounted on the assets, allowing the positions of both the assets and the vehicles to be tracked. Therefore, it can be seen which vehicles and assets are in the same location and/or are travelling together. However this method is not reliable in all situations, for example when multiple vehicles and assets start out from the same depot or when multiple vehicles are following the same route in a convoy. In such situations, the GPS signals may not be sufficiently precise to determine exactly which assets and vehicles are coupled. Further, the need to install GPS capable hardware on all assets can result in significant cost.

There remains a need for improved ways to remotely determine a coupling between an asset and a vehicle.

### SUMMARY OF THE INVENTION

According to a first aspect of the invention, there is provided a method for determining a coupling between an asset, and a vehicle capable of transporting the asset, the method comprising:
receiving input information indicating that one or more sensors are asset sensors located on the asset and mapping the asset sensors to the asset;
sending asset sensor data from the asset sensors located on the asset to a vehicle receiver device on a nearby vehicle via one or more wireless signals;
transmitting the asset sensor data from the vehicle receiver device to the remote server; and
using the mapping of the asset sensors at the remote server, and the subsequent transmission of the asset data from the asset sensors to the remote server via the vehicle receiver device, to determine whether a coupling exists between the nearby vehicle and the asset, based on the asset sensor data.

According to a second aspect of the invention, there is provided a method for determining a coupling between an asset, and a vehicle capable of transporting the asset, the method comprising:
receiving input information indicating that one or more sensors are asset sensors located on the asset and mapping the asset sensors to the asset;
sending asset sensor data from the asset sensors located on the asset to a vehicle receiver device on a nearby vehicle via one or more wireless signals;
transmitting the asset sensor data from the vehicle receiver device to the remote server; and
using the mapping of the asset sensors at the remote server to determine whether a coupling exists between the nearby vehicle and the asset, based on the asset sensor data.

According to a third aspect of the invention, there is provided an asset monitoring system comprising:
one or more asset sensors located on the asset;
a vehicle receiver device located on the vehicle; and
a remote server;
   wherein the system is configured to perform the method of the first aspect or of the second aspect.

It will be appreciated that in this method and system the mapping of the asset sensors to the asset, and subsequent transmission of the asset data from the asset sensors to the remote server via the vehicle receiver device may therefore be used to determine whether a coupling exists between an asset and a nearby vehicle. As will be further described below, the input information indicating that one or more sensors are asset sensors located on the asset is received in advance so that the mapping is available at the remote server when the asset sensor data is received. In this method, since the coupling is determined using sensors which are already present on the asset, and a vehicle receiver device, which is also likely already present in the vehicle for other purposes (for example the vehicle receiver device can be a telematics device as is typically used for fleet management purposes), the hardware cost is reduced compared to prior art methods which rely on GPS hardware being installed on every asset. Further, the method and system of the present invention may contribute to faster coupling detection as compared with GPS-based systems since the higher precision means less data is needed to achieve the same degree of confidence in a determined coupling.

In a set of embodiments, the one or more wireless signals are short range wireless signals. It will be understood that a short range wireless signal is one which does not require a network. For example, a short range wireless signal may be an Infrared signal. In various examples, a short range wireless signal is a radio-frequency signal transmitted by a short-range device (SRD), as described by ECC Recommendation 70-03. Example of short-range wireless signals include Bluetooth, Zigbee, Wi-Fi, near-field communication (NFC), ultra-wideband (UWB) and IEEE 802.15.4.

In a set of embodiments, the asset sensor data is transmitted from the vehicle receiver device to the remote server by a long range wireless signal, i.e. using a communications network. The vehicle receiver device may therefore comprise a modem or cellular network transceiver. For example, the vehicle receiver device may establish a “mobile” or telecommunications network connection with the remote server through a network service provider. The network connection can be established in a known manner, utilizing any number of communication standards such as 5G, LTE (4G), GSM (3G & 2G), CDMA (3G & 2G), WAN, etc.

In at least some embodiments, the system further comprises an asset receiver device located on the asset and configured to communicate with the one or more asset sensors, and with the vehicle receiver device such that the asset sensor data is sent by the asset sensors to an asset receiver device on the asset. In such embodiments, the method comprises connecting the asset receiver device to the vehicle receiver device via a (e.g. short range) wireless signal of the one or more wireless signals to communicate the asset sensor data from the asset receiver device to the vehicle receiver device.

The asset sensor data may be sent by the asset sensors to the asset receiver device by a wired and/or wireless connection. In other words, the one or more wireless signals may only be used to communicate the asset sensor data from the asset receiver device to the vehicle receiver device if all of the asset sensors are wired to the asset receiver device. However, in various embodiments the asset sensor data is sent by the asset sensors to the asset receiver device via the one or more wireless signals for ease of installation and retrofitting of sensors and/or the asset receiver device. Such embodiments may be particularly advantageous in situations where the vehicles and assets to be coupled are large, such as in the case of a heavy goods vehicle, and trailer. In such situations, a wireless communication transceiver as present on a sensor may not have sufficient range to communicate directly with the vehicle receiver device, and so the asset receiver device provides an intermediate communication device to relay the asset data from the asset sensors to the vehicle receiver device. Further, asset sensors may not be standardised, and may not be directly compatible with the vehicle receiver device, which may be a pre-existing component such as one of the LINK tracking devices available from Webfleet Solutions B.V. The asset receiver device may be configured to receive asset sensor data from different sensor types, and then send the asset sensor data in a format compatible with the vehicle receiver device.

In some embodiments, the asset receiver device may have a power source such as a battery. Alternatively, the asset receiver device may be powered by other means such as solar panels mounted on the asset, or dynamos present on the wheels of an asset.

In at least some embodiments, the asset receiver device may not have its own power source, and may be powered by the vehicle when the asset is coupled thereto. In these embodiments, the asset receiver device may be configured to apply a time marker to the asset sensor data when the asset is coupled to and powered by the vehicle. In such embodiments, the method comprises comparing the time marker to a power on time of the vehicle to validate the determined coupling between the asset and the vehicle. Therefore, the asset receiver device will only apply a time marker (such as a time stamp) to the asset sensor data when it is powered on, which will occur at the same time as the vehicle power was turned on. The power on time may be the ignition time (for a combustion engine vehicle) or a switch on time (for an electric vehicle), which of course may be initiated locally (e.g. by a driver carrying a key) or remotely (e.g. by a controller of an autonomous vehicle). Such embodiments may provide a greater degree of certainty that the determined coupling between asset and vehicle is a valid coupling.

The asset sensor data may consist solely of a sensor ID, such as a unique sensor ID code. However, in a set of embodiments the asset sensor data comprises asset sensor readings. In such embodiments, the method further comprises:
collecting vehicle sensor data comprising vehicle sensor readings from one or more vehicle sensors located on the vehicle; sending said vehicle sensor data to the vehicle receiver device, wherein said vehicle sensor readings correspond to said asset sensor readings; comparing said asset sensor readings and said vehicle sensor readings to determine a difference; and validating the determined coupling between the asset and the vehicle if the difference is below a predetermined difference value. Such embodiments may provide a greater degree of certainty that the determined coupling does exist between the asset and vehicle. In such embodiments, the vehicle sensor data may be sent to the vehicle receiver device by a wired and/or wireless connection.

Where it is disclosed herein that sensor readings correspond to other sensor readings, or where sensor readings from two or more separate sensors are described as corresponding, this means that the sensor readings are of the same type, and were taken at the same point in time, or over a period in time similar enough to allow the sensor readings to be meaningfully compared such that a coupling or mapping can be determined or validated based on the comparison of the sensor readings. For example, where the sensor readings comprise instantaneous wheel speed, the readings from different sensors will need to be taken at exactly the same in order for the readings to be corresponding, and a meaningful comparison be drawn. Conversely, where the readings comprise averaged values, it may be sufficient for the readings to be taken over approximately the same time period, but minor discrepancies in the length of the time period, or the exact start and end times of the period over which the averaged reading is taken are unlikely to affect the averaged value.

In a further set of embodiments, the method comprises transmitting from the vehicle receiver device both the asset sensor data and the vehicle sensor data to the remote server. In such embodiments, the comparing step is carried out at the remote server. In such embodiments, the vehicle receiver device may directly transmit the asset sensor data and the vehicle sensor data to the remote server, or this may take place indirectly e.g. via a modem or telematics device that provides a cellular network connection for communication with the remote server.

In those embodiments wherein vehicle sensor data is also collected, the method may further comprise: receiving input information indicating that one or more sensors are vehicle sensors located on the vehicle and mapping the vehicle sensors to the vehicle.

In various embodiments, the asset sensor data (and optionally the vehicle sensor data, in those embodiments wherein vehicle sensor data is also collected) is transmitted to the remote server via a telematics device inside the vehicle. The telematics device may be one of the LINK tracking devices available from Bridgestone Mobility (formerly Webfleet) Solutions B.V. In at least some embodiments, the telematics device may include a GPS sensor to generate vehicle travel data e.g. position, speed, etc. In these embodiments, the telematics device may include the vehicle receiver device (or vice versa) or the telematics device may be a separate device that is connected to vehicle receiver device.

In embodiments, a plurality of parameters from the asset and vehicle sensor readings are compared to validate the determined coupling between the asset and the vehicle, preferably instantaneous vehicle/asset speed and at least one other parameter. Such embodiments may provide a greater degree of certainty that the determined coupling between asset and vehicle is an asset coupling. Consider two vehicles with corresponding assets travelling in convoy. If the parameter being compared is the ambient temperature experienced by the asset sensors and vehicle sensors, since both vehicles and both assets are in the same area, the ambient temperature may be within threshold for both assets which could lead to an erroneous coupling, but it is much less likely that an asset has the same instantaneous wheel speed as a vehicle which is not transporting that asset.

In embodiments, comparing the asset sensor readings and the vehicle sensor readings comprises a comparison of instantaneous parameters from the sensor readings. In additional or alternative embodiments, comparing the asset sensor readings and the vehicle sensor readings comprises a comparison of averaged parameters from the sensor readings.

In embodiments the sensor readings comprise one or more parameters chosen from: instantaneous vehicle/asset speed, tire rotation speed, acceleration data, tire pressure data, tire temperature data, sensor battery status. In such embodiments the sensor readings comprise vehicle or asset data relating to the behaviour and properties of the vehicle/asset itself.

In additional or alternative embodiments, the sensor readings comprise one or more environment-related parameters such as ambient temperature sensor readings, ambient pressure sensor readings, ambient humidity sensor readings, altimeter readings and the like. Such environment-related parameters can be used to localise an asset to a nearby vehicle by determining that they are currently in the same environment. In such embodiments the sensor readings comprise environmental data relating to properties of the environment surrounding the vehicle/asset.

In additional or alternative embodiments, the sensor data may comprise video camera images, or data from proximity sensors or Radio Frequency (RF) beacons to recognise the presence of an asset or its cargo.

In embodiments, one or more of the asset sensors are tire mounted sensors mounted on tires of the asset.

In a further set of embodiments, the one or more vehicle sensors are tire mounted sensors mounted on tires of the vehicle.

Such embodiments may be convenient for taking readings such as instantaneous vehicle/asset speed (based on wheel speed), tire rotation speed, instantaneous vehicle/asset acceleration data (based on wheel speed and direction), and/or tire pressure data.

In a further set of embodiments, the asset tire mounted sensors and/or the vehicle tire mounted sensors are integrated with a tire pressure monitoring system (TPMS).

Additionally or alternatively, the asset tire mounted sensors and/or the vehicle tire mounted sensors may include Radio Frequency Identification (RFID) sensors mounted inside the tires.

In various embodiments, one or more of the asset sensors are self-powered sensors, e.g. powered by a battery or other local power source such as a photovoltaic cell or dynamo. Furthermore, one or more of the optional vehicle sensors may be self-powered sensors.

In a set of embodiments the input information indicating that one or more sensors are asset sensors located on the asset comprises a manual input provided at the point of installation of the one or more sensors. In a further set of embodiments, the manual input may be received via an application installed on a mobile device such as a smartphone. In such embodiments, the mobile device may connect directly to the one or more sensors via a short range wireless signal, and an installer may provide an input that the one or more sensors are installed on the asset. For example, the mobile device may pick up the RFIDs of the asset sensors and an installer may verify the number of sensors that are physically installed on the asset. Alternatively, the mobile device may not connect to the sensors, and the sensors may be identified by the mobile device via the installer scanning an ID code such as a QR code with the mobile device. In such embodiments the manual input means that the asset sensors can be mapped to the asset without needing an asset receiver device to detect the presence of the asset sensors.

In an additional or alternative set of embodiments, the input information indicating that one or more sensors are asset sensors located on the asset comprises an automatic detection of the one or more sensors by the vehicle receiver device. In an additional or alternative set of embodiments, the input information indicating that one or more sensors are asset sensors located on the asset comprises an automatic detection of the one or more sensors by the asset receiver device (where provided). Such an automatic detection may be realised via short-range pairing using a short range wireless signal such as Bluetooth® or Infrared. The asset receiver device located on the asset may be better positioned to automatically detect which asset sensors are present.

In at least some embodiments, in addition or alternatively, the input information comprises sensor data comprising sensor readings from a plurality of the one or more sensors indicating that the one or more sensors are asset sensors located on the asset. For example, the sensor readings (such as temperature) from unmapped sensors may be recognised as common sensor readings and hence this indicates to map the asset sensors to the asset. For example, the sensor readings from unmapped sensors may have the same time marker applied at the asset receiver device (where provided) and hence this indicates to map the asset sensors to the asset.

In an additional set of embodiments, mapping the asset sensors to the asset comprises comparing the sensor readings from one or more pre-mapped asset sensors to sensor readings from one or more unmapped asset sensors to determine a difference, and mapping the unmapped asset sensors to the asset if the difference is below a predetermined value. Such embodiments may allow further unmapped sensors to be mapped to an asset without operator input. For example, where a sensor is replaced due to a fault, or a depleted battery, the sensor may be mapped to the asset automatically when the comparison between the sensor readings from the new sensor, and the sensor readings from one or more of the existing pre-mapped sensors, shows that the readings are substantially the same, and as such, it can be derived that the new sensor is located on the same asset.

In at least some embodiments, the sensor readings comprise one or more parameters chosen from: instantaneous vehicle/asset speed, tire rotation speed, instantaneous vehicle/asset acceleration data, tire pressure data, tire temperature data, ambient temperature data.

It may be that the input information is indicative only that a particular sensor is located on an asset, and the subsequent mapping is of the sensor to the asset, but with no further information. For example, the input information could simply comprise a list of sensor IDs. However, in at least some embodiments, the input information is indicative of a position where each asset sensor is located on the asset (e.g. axle number, right/left side) and so the mapping may be a mapping of the sensor to the asset, and a mapping of the position of the sensor on the respective asset.

In a further set of embodiments, comparing said asset sensor readings and said vehicle sensor readings to determine a difference comprises comparing sensor readings from vehicle and asset sensors which have corresponding positions on the vehicle and asset respectively (e.g. comparing right side asset sensors with right side vehicle sensors). Such embodiments may help to reduce the likelihood of false couplings or de-couplings due to differences in sensor readings between the asset sensors and the vehicle sensors.

For example, where the sensor readings comprise tire rotation speed, when a vehicle and asset are turning, the tires on the inside of the turn will rotate slower than the tires on the outside of the turn. Therefore, a comparison between a left side asset tire sensor reading and a right side vehicle tire sensor reading could yield a difference above the threshold despite the respective vehicle and asset actually being coupled. In a further example, where the sensor readings comprise tire pressure, there may be differences in tire pressure between difference axles, for example where an asset is a trailer which is unevenly loaded. The tire pressures across the axle directly below the heavy load may be greater than the tire pressures across the axle at an opposite end of the trailer.

In at least some embodiments, a determined coupling is displayed on an output device, which may be a device operated by a fleet manager. The method may therefore further comprise: displaying a determined coupling on an output device, such as a fleet management terminal. The determined coupling may be displayed in any suitable way, for example on a live map, so that a user sees the position of all vehicles and assets and it is visually indicated which vehicles are coupled to which assets. In addition, or alternatively, the method may further comprise generating a coupling and/or decoupling alert. In some examples the method may comprise: sending a notification to a fleet manager when a new coupling or decoupling is determined. The automatic detection of vehicle and asset coupling enables a fleet manager to quickly detect wrongly chosen assets. The absence of coupling may be used to determine when assets are moving passively based on the asset sensor data (i.e. without a truck coupled to the asset) and hence notification of an uncoupled status is a theft protection feature.

In at least some embodiments, the method further comprises: using the mapping to assess the ratio of the number of asset sensors, which are sending asset sensor data to the vehicle receiver device (optionally via an asset receiver device), to an expected number of asset sensors located on the asset, and accepting the determined coupling only if said ratio is greater than a threshold value. In further embodiments, said threshold value is 0.5.

In at least some embodiments, the method further comprises: monitoring the wireless signal strength between the vehicle receiver device and one or more of the asset sensors, and optionally between the vehicle receiver device and the asset receiver device. In such embodiments, a determined coupling may not be accepted if the wireless signal strength is below a threshold value. This may be taken as an indication that the asset is not located in close enough physical proximity to the nearby vehicle for a coupling to be reliably determined. Alternatively, where there are a plurality of assets in wireless signal range of a vehicle receiver device, the asset receiver device or asset sensors having the highest wireless signal strength may be selected for coupling determination.

Where it is disclosed herein that a coupling is determined between an asset and a vehicle capable of transporting the asset, it will be understood that this coupling can be a physical coupling e.g. a trailer hitched to a truck, or a temporary association e.g. a piece of equipment being transported by or together with a vehicle in any suitable way. Most generally, a coupling means that the asset and vehicle are travelling together such that the asset follows the vehicle.

The applicant has appreciated that methods as disclosed herein can be useful for remotely monitoring an asset capable of being transported by a vehicle, and more generally for monitoring any moving asset (whether transportable by a vehicle or capable of transporting itself), in particular by exploiting a nearby vehicle receiver device to collect asset sensor data and transmit the asset sensor data to a remote server for monitoring purposes. This may be considered as a type of crowd-sourced data collection, leveraging the vehicle receiver devices (e.g. telematics devices) that are already widely distributed and available for communicating data from the field (e.g. to a fleet management server). The feature of mapping one or more asset sensors to a given asset, e.g. in advance of using the asset sensors to monitor the asset, means that the appropriate asset sensor data received at the remote server can be associated with the given asset. Various processing steps may then be carried out at the remote server to assess the asset sensor data, for example to remotely monitor the movement and/or behaviour of the asset out in the field.

Such an approach is considered novel and inventive in its own right. Thus, according to a further aspect of the invention, there is provided a method of remotely monitoring a moving asset, the method comprising:
receiving input information indicating that one or more sensors are asset sensors located on the asset and mapping the asset sensors to the asset;
sending asset sensor data from the asset sensors located on the asset to a vehicle receiver device on a nearby vehicle via one or more wireless signals;
transmitting the asset sensor data from the vehicle receiver device to the remote server; and
processing the asset sensor data at the remote server.

It will be understood that a nearby vehicle is one having a vehicle receiver device that is within wireless signal range of the asset sensors. In embodiments, the one or more wireless signals are short range wireless signals as already discussed above. A nearby vehicle may therefore be one that is located within about 10 metres of the asset sensors during the step of sending asset sensor data from the asset sensors to the vehicle receiver device. Once the vehicle receiver device has collected the asset sensor data then the vehicle can move away from the asset (or the asset can move away from the vehicle). At a later point in time, another vehicle may then become a nearby vehicle by the vehicle and/or asset moving into wireless signal range of one another.

In some embodiments, the moving asset is an asset capable of being transported by a vehicle.

As described above, in preferred embodiments the asset sensor data is transmitted from the vehicle receiver device to the remote server by a long range wireless signal, i.e. using a telecommunications network. Many vehicles already have such a vehicle receiver device installed for tracking purposes. In these methods of remotely monitoring a moving asset, it is possible to collect asset sensor data using an available nearby vehicle without requiring the presence of a dedicated asset receiver device.

Any of the embodiments already described above may be implemented as embodiments of this further aspect of the invention. In particular, the method may further comprise: sending at least some of the asset sensor data (via a wired or wireless connection) from the asset sensors located on the asset to an asset receiver device located on the asset, wherein the asset receiver device is connected to the vehicle receiver device via a wireless signal of the one or more wireless signals (e.g. a Bluetooth pairing). At least some of the asset sensor data may therefore be wirelessly communicated from the asset receiver device to the vehicle receiver device on a nearby vehicle. This can help to ensure reliable collection of asset sensor data, with the asset receiver device acting as a gateway to channel the asset sensor data to a nearby vehicle receiver device.

In any of the aspects and embodiments disclosed herein, the step of mapping the asset sensors to the asset will be understood as associating the asset sensors with a particular asset in any suitable data representation. This mapping acts to effectively group together those asset sensors which have been indicated by the input information to be physically located on a particular asset. The mapping may be a simple as associating a list of asset sensor IDs with a particular asset. It will be appreciated that the mapping can be a virtual step taking placed in any computer that receives the input information, e.g. an installer's mobile device or the vehicle/asset receiver device. In various embodiments, the input information is received at the remote server and the remote server is configured to map the asset sensors to the asset. The remote server may include (or be connected to) a memory that stores the mapping, e.g. a list of associated asset sensor IDs for each asset.

In any of the aspects and embodiments disclosed herein, it will be understood that one or more of the vehicle sensors and/or asset sensors may be integral elements of the vehicle and/or asset respectively. Alternatively, one or more of the vehicle and/or asset sensors may be removably fixed to the vehicle and/or asset respectively such that the sensors can be removed and replaced.

In any of the aspects and embodiments disclosed herein, it will be understood that the asset sensor data being transmitted from the vehicle receiver device to the remote server may not be the same as the raw sensor data collected by the asset sensors. For example, the asset sensor data sent wirelessly from the asset sensors (directly and/or via an asset receiver device) may be processed to a degree by a processor in the vehicle receiver device, for example by applying some edge processing to aggregate or compress the asset sensor data or otherwise reduce the bandwidth requirement for transmitting the asset sensor data to the remote server.

In any of the aspects and embodiments disclosed herein, where a sensor or receiver device is described as being located on an asset/vehicle, it will be understood that this refers to the physical presence of the hardware (e.g. asset/vehicle sensor, asset/vehicle receiver device) as a result of it being mounted to carry out its function(s) as a sensor or receiver device.

In some embodiments the asset/vehicle receiver device is a mobile device carried by the asset/vehicle (i.e. removably located thereon). In some embodiments the asset/vehicle receiver device is a fixed device carried by the asset/vehicle (i.e. semi-permanently or permanently located thereon). For example, the vehicle receiver device may be plugged into an On-Board Diagnostics (OBD) port and the asset receiver device (where provided) may be plugged into an asset port of an internal communications network (such as a CAN bus) of the asset and/or vehicle. The fixed device may include mechanical and/or electrical mounting means (e.g. for connecting to the power supply from the vehicle's battery). Preferably the vehicle receiver device is a fixed device in the vehicle, for example plugged into an On-Board Diagnostics (OBD) port or even integrated with the on-board vehicle computer. The fixed device may include mechanical and/or electrical mounting means (e.g. for connecting to the power supply from the vehicle battery). The vehicle receiver device being a fixed device means that it is not intended to be regularly removed and carried by a user in the form of a mobile device, however the fixed device may still be installable and removable rather than being an absolutely permanent fixture in the vehicle. In other words, the vehicle receiver device may be manufactured by a third party and installed in a vehicle subsequent to its manufacture, for example as part of a fleet management system. The vehicle receiver device can therefore be distinguished from any onboard data processing systems installed by the vehicle manufacturer. In various examples, the vehicle receiver device may comprise one of the LINK tracking devices available from Bridgestone Mobility (formerly Webfleet) Solutions B.V.

It will of course be appreciated that the term ‘remote server’ as used herein means a computer or machine (e.g. server device) connected to a network such that the server sends and/or receives data from other devices (e.g. computers or other machines) on that network without being in physical proximity. Additionally or alternatively, the server may provide resources and/or services to other devices on the network. The network may be the Internet or some other suitable network. The server may be embodied within any suitable server type or server device, e.g. a file server, application server, communications server, computing server, web server, proxy server, etc. The server may be a single computing device, or may be a distributed system, i.e. the server functionality may be divided across a plurality of computing devices. For example, the server may be a cloud-based server, i.e. its functions may be split across many computers ‘on demand’. In such arrangements, server resources may be acquired from one or more data centres, which may be located at different physical locations.

It will thus be appreciated that the processes described above which are carried out by the remote server, may be carried out by a single computing device, i.e. a single server, or by multiple separate computing devices, i.e. multiple servers. For example, all of the processes may be carried out by a single server which has access to all the relevant information needed.

Any of the methods disclosed herein can be computer-implemented methods.

### BRIEF DESCRIPTION OF THE DRAWINGS

One or more non-limiting examples will now be described, by way of example only, and with reference to the accompanying figures in which:

FIG. 1 is a schematic overview of an asset monitoring system in accordance with an embodiment of the present invention;

FIG. 2 is a schematic overview of a vehicle and asset having elements of the system of FIG. 1 installed thereon;

FIG. 3 is a schematic view of an input device in accordance with an embodiment of the present invention;

FIG. 4 is a flow chart showing a method for determining a coupling between an asset, and a vehicle capable of transporting that asset, in accordance with an embodiment of the present invention;

FIG. 5 is a flow chart showing method steps which are additional to the method steps shown in FIG. 4, associated with an embodiment of the present invention;

FIG. 6 is a flow chart showing further method steps which are additional to the method steps shown in FIG. 4, associated with an embodiment of the present invention.

### DETAILED DESCRIPTION OF PREFERRED EMBODIMENTS

In the illustrated embodiment described below, the vehicle 3 is a Heavy Goods Vehicle (HGV) and the asset 5 is a trailer that can be physically coupled to the HGV. However, it will be appreciated that the same system and method can be applied to monitor any asset that comes into proximity of the vehicle, regardless of whether the vehicle and asset are intended to be physically coupled together or not.

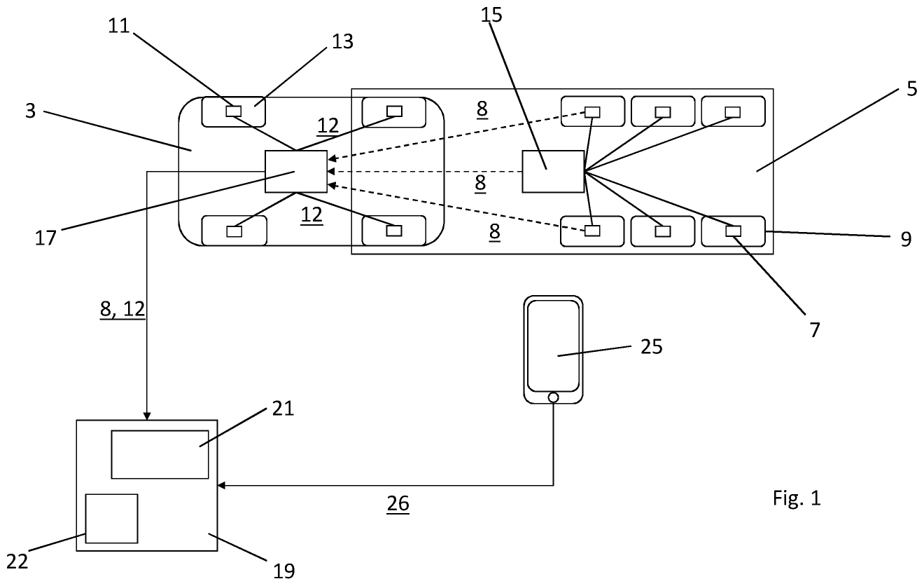

FIG. 1 is a schematic overview showing an asset monitoring system 1, installed on a vehicle 3 and corresponding asset 5. Mounted on the asset 5 are a plurality of asset sensors 7 which are configured to generate asset sensor data 8. In the illustrated embodiment, the asset sensors 7 are tire sensors mounted on the tires 9 of the asset 5. In the illustrated embodiment, the vehicle 3 is similarly equipped with vehicle sensors 11 which are configured to generate vehicle sensor data 12. In the illustrated embodiment, the vehicle sensors 11 are tire sensors mounted on the tires 13 of the vehicle 3.

In the current application, the asset sensors 7 and vehicle sensors 11 generate asset sensor data 8 and vehicle sensor data 12 respectively. In the current application, asset sensor data 8 and vehicle sensor data 12 are defined as sensor data which contains details about the sensor itself, and/or the asset/vehicle on which the sensor is mounted. For example, the asset sensor data 8 and/or vehicle sensor data 12 may comprise a sensor ID 14. Additionally or alternatively, the asset sensor data 8 and/or vehicle sensor data 12 may comprise sensor readings which contain details about the asset/vehicle on which the sensor is mounted such as instantaneous asset/vehicle speed, tire rotation speed, acceleration data, tire pressure data, tire temperature data, ambient temperature data, sensor battery status, or sensor data in the form of video camera images, or proximity data.

Further, located on the asset 5 in the illustrated embodiment is an optional asset receiver device 15, and located on the vehicle is a vehicle receiver device 17 which is configured to communicate with the asset sensors 7 via one or more wireless signals, either directly or via the asset receiver device 15 (shown by the dotted lines). In this illustrated embodiment, the asset receiver device 15 is connected to the vehicle receiver device 17 via a short-range wireless signal such as Bluetooth®.

In this illustrated embodiment, the asset sensors 7 are capable of sending asset sensor data 8 directly to the vehicle receiver device 17 via wireless signals (dotted lines) or to the asset receiver device 15, either via a wired or wireless connection (solid lines). The vehicle sensors 11 are capable of sending vehicle sensor data 12 to the vehicle receiver device 17, either via a wired or wireless connection (solid lines).

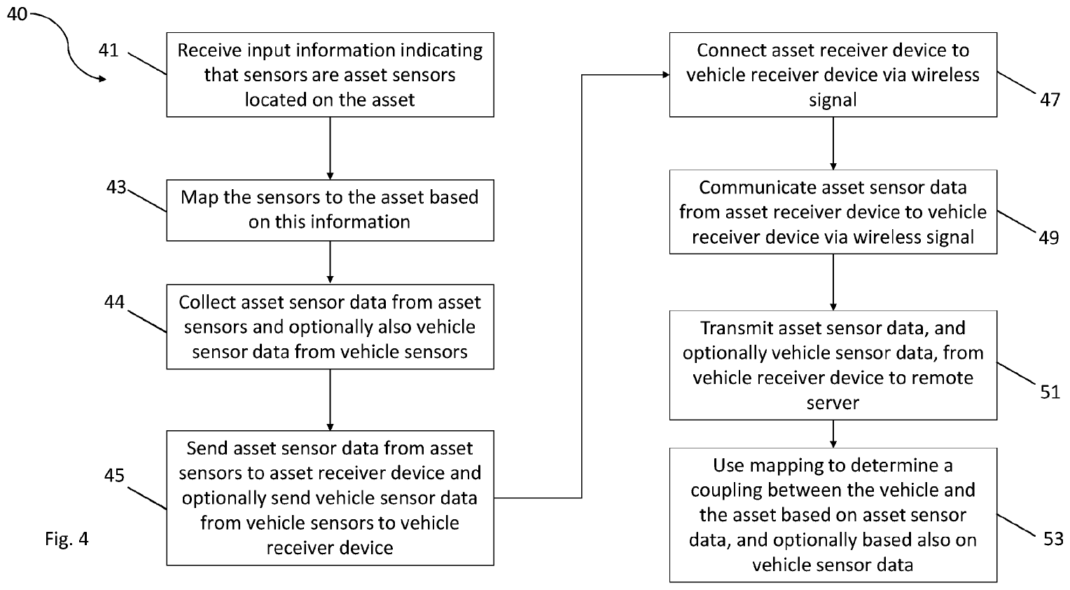

The system further comprises a remote server 19 which, as depicted, is located remotely from, and outside of, the vehicle 3. The server 19 comprises a processor 21 and a memory 22 which store a computer product comprising computer-executable instructions to perform a method for determining a coupling between an asset and a vehicle capable of transporting that asset. The processor 21 may comprise one or more processing devices, for example multiple processing devices arranged in series or parallel. The method for determining a coupling between an asset and a vehicle capable of transporting that asset is shown in FIGS. 4 to 6 and described in more detail below. The server 19 may comprise a computer readable medium having an algorithm stored thereon.

The vehicle receiver device 17 may be a telematics device that is connected to, or is an integral part of the vehicle 3. For example, the vehicle receiver device 17 may be connected to an On-Board Diagnostics (OBD) port of the vehicle 3. The vehicle receiver device 17 may be temporarily, or permanently, installed on the vehicle 3. In some examples, the vehicle receiver device 17 may comprise one of the LINK tracking devices available from Webfleet Solutions B.V.

The system 1 further comprises an input device 25 which is configured to receive input information 26 from a user, such as an installer of the asset sensors 7, and send said input information 26 to the remote server 19. In the illustrated embodiment, the input information 26 comprises the positions of one or more asset sensors 7 on the asset 5. The input device 25 may be a user's smart phone with an application installed thereon. The input device 25 is used to transmit input information 26 indicating that the asset sensors 7 are located on the asset 5 to the remote server 19, where it is used to map the asset sensors 7 to the asset 5.

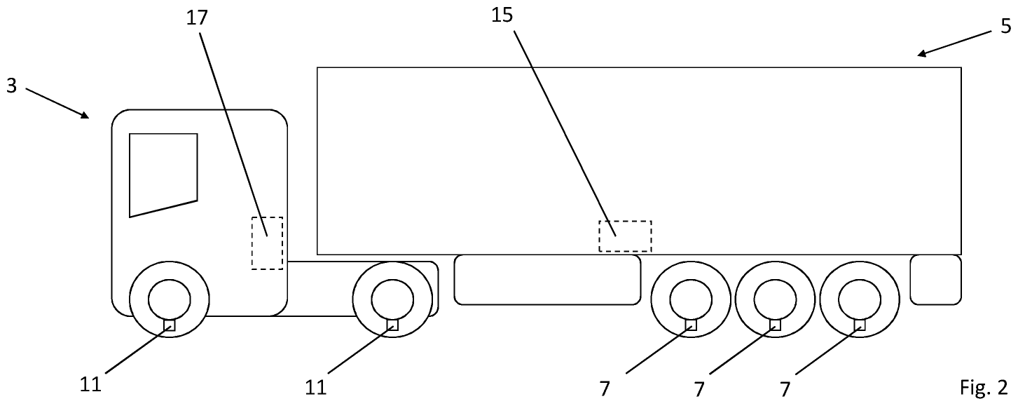

FIG. 2 shows a schematic overview of a vehicle 3 and asset 5 with vehicle sensors 11, asset sensors 7, vehicle receiver device 17 and an optional asset receiver device 15 installed thereon.

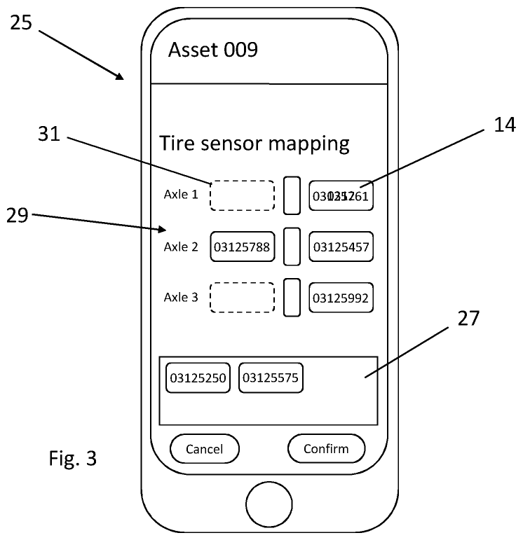

FIG. 3 shows an input device 25 which is a smart phone with an application installed thereon. The input device 25 is configured to receive input information 26 indicating that sensors are asset sensors 7 located on the asset 5. In the illustrated embodiment, the ID codes of unmapped sensors are shown in the unmapped sensor area 27. The sensor ID codes of unmapped sensors may be stored on the server 19 and the list of unmapped sensors may be sent to the input device 25 via a wireless network. In the illustrated embodiment, the sensors are tire sensors and so the input device 25 displays a tire topology diagram 29 having drop boxes 31 corresponding to the positions of the asset tires 9 into which a user can drag sensor IDs from the unmapped sensor area 27 to the correct position of the sensor on the asset 5. The sensor ID can be obtained by the input device in a plurality of ways. For example, as stated above, the sensor IDs may be stored in the server 19 and sent to the input device 25 via a wireless network. Alternatively, if the sensor is a new sensor which has not previously been mapped (such as a replacement sensor introduced because of a fault or depleted battery on a previous sensor), then the sensor ID 14 may be obtained directly by the input device 25. The input device 25 may obtain the sensor ID 14 by scanning a QR code, or the user may manually enter the ID code 14 into the user device (for example after reading the ID code 14 printed on the exterior of the sensor). Alternatively, the sensors may connect to the input device via a short-range wireless signal such a Bluetooth® or infrared when the user device is close to the asset 5, and the ID code of the sensors may be transmitted to the input device 25 in a known way. Once the user has finished entering the input information 26 at the input device 25, the input device 25 transmits said input information to the server 19 via a wireless network, and the sensors are mapped to the asset 5 at the server 19. The server 19 stores the mapping of asset sensors.

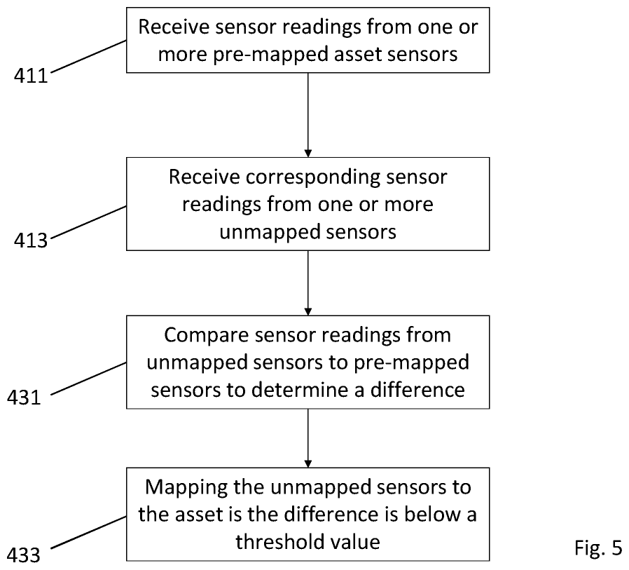

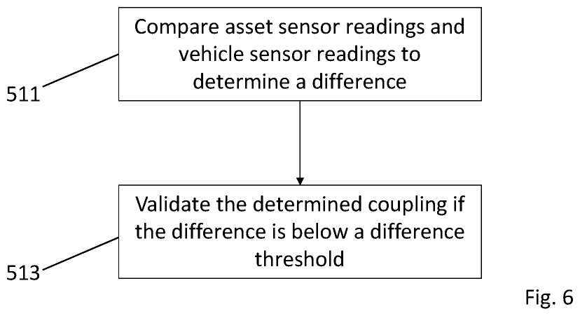

In the above described embodiment, the mapping contains details not only of which sensors are asset sensors 7 located on the asset 5, but also where on the asset 5 those asset sensors 7 are located. Such information may be advantageous to later steps of the method, particularly those discussed in relation to FIG. 5 and FIG. 6, where sensor readings are compared to reduce the likelihood of false couplings or de-couplings, and false mappings due to differences in sensor readings between the asset sensors and, in embodiments the vehicle sensors. For example, where the sensor readings comprise tire rotation speed, when a vehicle 3 and asset 5 are turning, the tires on the inside of the turn will rotate slower than the tires on the outside of the turn. Therefore, a comparison between a left side asset tire sensor reading and a right side vehicle or asset tire sensor reading could yield a difference above the threshold despite the respective vehicle and asset actually being coupled or despite the asset sensor 7 being located on the same asset 5. In a further example, where the sensor readings comprise tire pressure, there may be differences in tire pressure between difference axles, for example where an asset 5 is a trailer which is unevenly loaded. The tire pressures across the axle directly below the heavy load may be greater than the tire pressures across the axle at an opposite end of the trailer.

It will be understood that the input information 26 can take other forms, and may not be input manually at an input device 25, as discussed below in relation to FIG. 5.

FIG. 4 shows a flow chart illustrating the method 40 for determining a coupling between an asset 5 and a vehicle capable of transporting that asset 3. At step 41, input information 26 is received, indicating that sensors are asset sensors 7 located on the asset 5. This input information 26 could be information entered manually by a user at an input device 25 as explained above in relation to FIG. 3. Alternatively, the input information could take other forms, as discussed below in relation to FIG. 6.

At step 43, the unmapped sensors are mapped to the asset 5 based on the input information. In embodiments where the input information 26 comprises a direct manual input that the sensors are located on the asset 5, the mapping is simple. However, in embodiments where the input information 26 does not directly state that the sensors are asset sensors 7 located on the asset 5, but is indicative of that fact, the mapping step 43 itself comprises a plurality of steps which are discussed below in relation to FIG. 6.

Once the mapping is complete, it is known that the sensors are asset sensors 7 located on the asset 5. Steps 41 and 43 are therefore precursor steps that are carried out at any time before it is desired to determine a coupling (typically in real-time) between a given asset 5 and a vehicle 3 capable of transporting the asset 5. At any subsequent time, at step 44, asset sensor data 8 is collected from the asset sensors 7. In embodiments where the asset sensor 8 comprises asset sensor readings, the step may further comprise collecting corresponding vehicle sensor data 12 comprising vehicle sensor readings from vehicle sensors 11.

At step 45, asset sensor data 8 from the asset sensors 7 is sent from the asset sensors 7 to the asset receiver device 15. The data can be sent via a wired or wireless connection. The data may be sent by a short range wireless signal such as Bluetooth® or infrared. At step 47, the asset receiver device 15 is connected to the vehicle receiver device 17 via a short range signal such as Bluetooth® or infrared. The use of a short-range signal ensures that connection will only occur between vehicle receiver devices 17 and asset receiver devices 15 which are in range. In principle, the possibility of such a short-range connection between receiver devices is an indication that the respective vehicle 3 and asset 5 are coupled. At step 49, the asset sensor data 8 is communicated from the asset receiver device 15 to the vehicle receiver device 17 via the short-range wireless signal. In other embodiments, steps 45, 47 and 49 are replaced with a single step in which the asset sensor data 8 is sent directly, via one or more wireless signals, from the asset sensors 7 to the vehicle receiver device 17.

At step 51, the asset sensor data, and optionally the vehicle sensor data 12 if this was collected at step 44, is transmitted from the vehicle receiver device to the remote server 19 via a wireless network. At step 53, which is carried out at the remote server 19, the mapping is used to determine a coupling between the vehicle 3 and the asset 5. In embodiments where vehicle sensor data 12 is not collected, the coupling is determined based on the route the asset sensor data took to arrive at the server 19. Considering the embodiment where the asset sensor data 8 comprises the sensor ID code 14. It is known from the mapping that the asset sensor 7 associated with said asset sensor ID code 14 is located on a first asset 5. Further, the asset sensor data 8 containing said asset sensor ID code 14 was sent to the server 19 by a first vehicle receiver device 17 which is located on a first vehicle. Therefore, the asset receiver device 15 on the first asset 5 (on which the asset sensor 7 is located) must have been in range of the short-range wireless signal connecting the first vehicle receiver device 17 and the asset receiver device 17 on the first asset 5. It can therefore be determined that the first asset 5 and the first vehicle 3 are coupled. It will be understood that the larger the number of asset sensors 7, and thus the amount of asset sensor data 8, the more reliable the coupling.

It will be appreciated that the asset 5 may be coupled to a different vehicle 3 at different points in time. The precursor steps 41, 43 do not need to be repeated as long as the same asset sensors 7 are still located on the asset 5. At any subsequent time, the steps 44, 45, 47, 49, 51, 53 may be repeated to determine afresh if a coupling exists between the asset 5 and another vehicle 3 capable of transporting the asset 5.

A potential short fall of the above described embodiment, is the possibility of false couplings when a plurality of vehicles 3 and/or assets 5 are very close together, for example if a plurality of vehicles 3 and assets 5 are leaving a haulage yard at the same time, or are travelling in a close convoy. In such situations, it is possible that the asset receiver device 15 of an asset 5 may be in range of a vehicle receiver device 17 located on a vehicle 3 which is close to the asset 5, but to which the asset 5 is not coupled. In this situation, the asset sensor data could be sent to the vehicle receiver device 17 on the uncoupled vehicle 3, and then be sent to the server 19 by said vehicle receiver device 17, resulting in a false coupling.

In embodiments, the method 40 comprises additional steps to validate the determined coupling. The asset sensors 7 may be powered by an independent power source such a battery (not shown) and therefore may send asset sensor data to the asset receiver device 15 even when the vehicle 3 and asset 5 are parked and the vehicle power is turned off. By contrast, the asset receiver device may be powered by the vehicle's power source, and therefore may not receive asset sensor data 8 from the asset sensors 7 until the vehicle is switched on. In the currently described embodiment, when the vehicle power is switched on, the asset receiver device 15 receives asset sensor data 8 from the asset sensors 7 and applies a time stamp to the data. Since the asset receiver device 15 is powered by the vehicle's power supply, this time stamp will correspond to the time at which the vehicle 3 was switched on. In embodiments, the vehicle receiver device 15 is a telematics device connected to an OBD port of the vehicle. In such embodiments, the vehicle receiver device 17 will collect vehicle data comprising the time at which the vehicle was switched on. In the currently described embodiment, this data is sent from the vehicle receiver device 17 via a wireless network, to the remote server 19, along with the timestamped asset sensor data 8. At step 51, when determining the coupling, the server 19 compares the timestamp on the asset sensor data 8 with the vehicle power on time from the vehicle data, and if the times match, a coupling between the asset 5 and the vehicle 3 is determined. It will be understood that such embodiments are less susceptible to false couplings since the probability of an asset 5 being in range of a vehicle 3 to which it is not coupled, and further being coupled to a vehicle which has the same power on time as the vehicle to which the asset is not coupled is very low.

As discussed above in relation to FIG. 3, the mapping of sensors to an asset 5 may comprise receiving input information 26 which is information input by a user at a user input device 25 that the sensors are asset sensors 7 located on the asset 5. In other embodiments however, the mapping may be performed automatically, and the input information 26 may be sensor data which may comprise sensor readings. FIG. 5 is a flow diagram showing the additional steps which are performed within steps 41 and 43 of FIG. 4 when the input information is sensor data comprising sensor readings. At step 41, the input information 26 is received. In this embodiment, step 41 comprises steps 411 and 413. At step 411, sensor readings are received from one or more pre-mapped asset sensors 7. At step 413, corresponding sensor readings are received from one or more unmapped sensors, Such an embodiment may be useful when one or more asset sensors are being replaced, for example because of a fault or depleted battery on a previous sensor. In such situations, it is likely that at least one asset sensor 7 will not need replacing, and so can act as the pre-mapped sensor. Step 43 comprises steps 431 and 433. At step 431, the sensor readings from the unmapped sensors are compared to the sensor readings from the pre-mapped sensors to determine a difference, and at step 433, this difference is compared to a predetermined value, and the unmapped sensors are mapped to the asset 5 if the difference is below the predetermined value. This comparison step could be performed by any suitable hardware. For example, the data may be sent to the remote server 19 for the comparison to be performed at the remote server 19. In embodiments where the sensor data from pre-mapped and unmapped sensors is sent to the remote server 19, it may be sent via the vehicle receiver device as previously discussed. Alternatively, the data may be transmitted to the mobile device 25, and the comparison step may be performed by the processing hardware of the mobile device 15. The currently discussed embodiment works on the principle that sensors which are mounted on the same asset 5 should generate sensor readings which are the same, or very similar. For example, if the sensors are tire rotation speed sensors, and 5 pre-mapped asset sensors 7 are all showing the same instantaneous tire rotation speed, if sensor readings are received from an un-mapped sensor which show the same instantaneous tire rotation speed as the 5 pre-mapped asset sensors 7, it is highly likely that the unmapped sensor is located on the same asset as the pre-mapped sensor, and therefore, the unmapped sensor is mapped to the asset 5. It will be understood that sensor readings other than tire rotation speed may be used in the above described embodiment, and that the above example is provided for illustrative purposes only.

Additionally or alternatively, the mapping may be based off a comparison of time stamps applied to the asset sensor data 8 by the asset receiver device 15. The asset receiver device may be powered by the vehicle power source, and therefore may not receive asset sensor data 8 from the asset sensors 7 until the vehicle is switched on. In the currently described embodiment, when the vehicle power is switched on, the asset receiver device 15 receives asset sensor data 8 from the asset sensors 7 and applies a time stamp to the data. Since the asset receiver device 15 is powered by the vehicle 3, this time stamp will correspond to the time at which the vehicle 3 was switched on. Therefore, the time stamps present in the asset sensor data 8 can be compared (for example at the remote server 19), and if, for example, an unmapped sensor shows the same timestamp as 5 pre-mapped asset sensors 7, it is highly likely that the unmapped sensor is located on the same asset as the pre-mapped sensors 7, and therefore, the unmapped sensor is mapped to the asset 5.

In embodiments, the method further comprises validating the determined coupling between an asset 5 and a vehicle 3. In such embodiments, step 44 of the method 40 shown in FIG. 4 comprises collecting vehicle sensor data 12 from vehicle sensors 11, step 45 comprises sending vehicle sensor data 12 from vehicle sensors 11 to the vehicle receiver device 17, step 49 comprises transmitting the vehicle sensor data 12 from the vehicle receiver device 17 to the remote server 19, and step 51 comprises validating the coupling based on both the asset sensor data 8, and the vehicle sensor data 12 by carrying out steps 511 and 513 shown in FIG. 6. In such embodiments, both the vehicle sensor data 12 and the asset sensor data 8 comprise corresponding sensor readings. At step 511, which takes place at the remote server 19, the asset sensor readings are compared to the vehicle sensor readings to determine a difference, and at step 513, the coupling between the asset 5 and vehicle 3 is validated if the difference is below a predetermined value. The currently discussed embodiment works on the principle that sensors which are mounted on a vehicle 3 and asset 5 which are coupled and therefore travelling together should generate sensor readings which are the same, or very similar. For example, if the sensors are tire rotation speed sensors, the tire rotation speed sensors on the asset 5 should measure the same instantaneous tire rotation speed as the tire rotation speed sensors on the vehicle 3. It will be understood that sensor readings other than tire rotation speed may be used in the above described embodiment. It will be understood that sensor readings other than tire rotation speed may be used in the above described embodiment, and that the above example is provided for illustrative purposes only.

In the illustrated embodiments, the asset 5 is provided with an asset receiver device 15 which acts as a relay between the asset sensors 7 and the vehicle receiver device 17. The asset receiver device 15 is advantageous because the size of assets such as HGV trailers means that whilst asset sensors 7 near the front of a trailer may be in short-range wireless signal range of the vehicle receiver device 15, and therefore able to connect the vehicle receiver deice 15 directly, asset sensors 7 near the back of the trailer are unlikely to be in range, hence a relay device is needed. Further, as explained above, a plurality of different sensor types can be used to perform the method of the invention, and if the vehicle receiver device 15 is provided by an existing vehicle component such as an integral telematics device, this vehicle receiver device 17 may not be compatible with sensor data 8 generated by all asset sensor types. By providing a dedicated asset receiver device 15, the asset receiver device 15 can be designed to be compatible with a plurality of sensor types, and to convert the asset sensor data 8 received into a format which is compatible with the vehicle receiver device 17. It will be understood that the asset receiver device may process the asset sensor data 8 before sending it to the vehicle receiver device 17. Such processing may comprise edge processing, or data compression. It is further envisaged that in embodiments where data is sent directly from the asset sensors 7 to the vehicle receiver device, or in embodiments where the asset sensor data 8 is sent via an asset receiver device 15, processing steps may be performed by the asset sensors themselves, or by a processor (not shown) mounted with and connected to each asset sensor 7.

In embodiments, it is envisaged that the method 40 further comprises using the mapping to assess the ratio of the number of asset sensors 7 which are sending asset sensor data 8 to the asset receiver device 15 or directly to the vehicle receiver device 17, to an expected number of asset sensors 7 located on the asset 5, and accepting the determined coupling only if said ratio is greater than a predetermined value. For example, the asset 5 shown in FIG. 1 and FIG. 2 has 6 wheels, and so if the asset sensors are tire mounted sensors, then 6 asset sensors are expected. If the predetermined value is set to 0.5, then a coupling with the asset 5 will be accepted only if the number of asset sensors 7 which are mapped to the asset 5 and are sending asset sensor data 8 is greater than or equal to 3.

In embodiments, it is envisaged that the method 40 further comprises monitoring the signal strength between the vehicle receiver device 17 and the asset receiver device 1 or the asset sensors 7. In such embodiments, a determined coupling may not be accepted if the signal strength is below a predetermined value. Alternatively, where there are a plurality of assets in signal range of a vehicle receiver device 17, the asset 5 with the asset receiver device 15 or asset sensors 7 having the highest signal strength when connected to the vehicle receiver device 17 may be selected for coupling on the basis that the asset 5 which is coupled to the vehicle 3 should be the asset 5 which is closest to the vehicle 3, and will therefore have the highest signal strength.

1. A method for determining a coupling between an asset, and a vehicle capable of transporting the asset, the method comprising:
receiving input information indicating that one or more sensors are asset sensors located on the asset and mapping the asset sensors to the asset;
sending asset sensor data from the asset sensors located on the asset to a vehicle receiver device on a nearby vehicle via one or more wireless signals;
transmitting the asset sensor data from the vehicle receiver device to the remote server; and
using the mapping of the asset sensors at the remote server, and the subsequent transmission of the asset data from the asset sensors to the remote server via the vehicle receiver device, to determine whether a coupling exists between the nearby vehicle and the asset, based on the asset sensor data.

2. The method of claim 1, wherein the asset sensor data is sent by the asset sensors to an asset receiver device on the asset, and wherein the method comprises:
connecting the asset receiver device to the vehicle receiver device via a wireless signal of the one or more wireless signals to communicate the asset sensor data from the asset receiver device to the vehicle receiver device.

3. The method of claim 2, wherein the asset receiver device is configured to apply a time marker to the asset sensor data when the asset is coupled to and powered by the vehicle, the method further comprising:
comparing said time marker to a power on time of the vehicle to validate the determined coupling between the asset and the vehicle.

4. The method of claim 1, wherein the asset sensor data comprises asset sensor readings, and the method further comprises:
collecting vehicle sensor data comprising vehicle sensor readings from one or more vehicle sensors located on the vehicle;
sending said vehicle sensor data to the vehicle receiver device, wherein said vehicle sensor readings correspond to said asset sensor readings;
comparing said asset sensor readings and said vehicle sensor readings to determine a difference; and
validating the determined coupling between the asset and the vehicle if the difference is below a predetermined difference value.

5. The method of claim 4, wherein the method further comprises:
transmitting from the vehicle receiver device both the asset sensor data and the vehicle sensor data to the remote server, and wherein the comparing step is carried out at the remote server.

6. The method of claim 4, wherein comparing the asset sensor readings and the vehicle sensor readings comprises a comparison of instantaneous/averaged parameters from the sensor readings.

7. The method of claim 4, wherein the sensor readings comprise one or more parameters chosen from: instantaneous vehicle/asset speed, tire rotation speed, acceleration data, tire pressure data, tire temperature data, atmospheric temperature data, sensor battery status.

8. The method of claim 1, wherein the input information comprises a manual input provided at the point of installation of the one or more sensors.

9. The method of claim 2, wherein the input information comprises an automatic detection of the one or more sensors by the asset receiver device.

10. The method of claim 1, wherein the input information comprises sensor data comprising sensor readings from a plurality of the one or more sensors indicating that the one or more sensors are asset sensors located on the asset.

11. The method of claim 10, wherein mapping the asset sensors to the asset comprises comparing the sensor readings from one or more pre-mapped asset sensors to sensor readings from one or more unmapped asset sensors to determine a difference, and mapping the unmapped asset sensors to the asset if the difference is below a predetermined value.

12. The method of claim 1, wherein the input information is indicative of a position where each asset sensor is located on the asset.

13. The method of claim 12, wherein the asset sensor data comprises asset sensor readings, and the method further comprises:
collecting vehicle sensor data comprising vehicle sensor readings from one or more vehicle sensors located on the vehicle;
sending said vehicle sensor data to the vehicle receiver device, wherein said vehicle sensor readings correspond to said asset sensor readings;
comparing said asset sensor readings and said vehicle sensor readings to determine a difference; and
validating the determined coupling between the asset and the vehicle if the difference is below a predetermined difference value;
wherein comparing said asset sensor readings and said vehicle sensor readings to determine a difference comprises comparing sensor readings from vehicle and asset sensors which have corresponding positions on the vehicle and asset respectively.

14. A method for determining a coupling between an asset, and a vehicle capable of transporting the asset, the method comprising:
receiving input information indicating that one or more sensors are asset sensors located on the asset and mapping the asset sensors to the asset;
sending asset sensor data from the asset sensors located on the asset to a vehicle receiver device on a nearby vehicle via one or more wireless signals;
transmitting the asset sensor data from the vehicle receiver device to the remote server; and
using the mapping of the asset sensors at the remote server to determine whether a coupling exists between the nearby vehicle and the asset, based on the asset sensor data.

15. An asset monitoring system comprising: one or more asset sensors located on the asset; a vehicle receiver device located on the vehicle; and a remote server; wherein the system is configured to perform the method of claim 1.

16. A system according to claim 15, further comprising an asset receiver device located on the asset and configured to communicate with the one or more asset sensors, and to transmit asset sensor data to the vehicle receiver device via a wireless signal of the one or more wireless signals.
